(19) United States
(12) Patent Application Publication
(10) Pub. No.: US 2025/0335231 A1
(43) Pub. Date: Oct. 30, 2025

(54) METHOD, DEVICE, AND COMPUTER PROGRAM PRODUCT FOR MIGRATING VIRTUAL MACHINE

(71) Applicant: Dell Products L.P., Round Rock, TX (US)

(72) Inventors: Chi Chen, Chengdu (CN); Changyue Dai, Chengdu (CN); Hailan Dong, Chengdu (CN)

(21) Appl. No.: 18/931,283

(22) Filed: Oct. 30, 2024

(30) Foreign Application Priority Data
Apr. 26, 2024 (CN) 202410516677.4

(51) Int. Cl. G06F 9/455; G06F 11/34

(52) U.S. Cl. CPC G06F 9/45558; G06F 11/3452; G06F 11/3466; G06F 2009/4557

(57) ABSTRACT

Techniques are directed to migrating a virtual machine. Such techniques involve acquiring a source operation status of a virtual machine on a source-type datastore. Such techniques further involve determining a plurality of candidate migration actions for migrating the virtual machine from the source-type datastore to various types of datastores respectively. Such techniques further involve determining a plurality of action scores based on the source operation status and the plurality of candidate migration actions. Such techniques further involve selecting a target action based on the plurality of action scores. Such techniques further involve migrating the virtual machine from the source-type datastore to a target-type datastore indicated by the target action by performing the target action. Accordingly, an optimal type of the datastore for the virtual machine is found based on the operation status of the virtual machine, thereby enhancing the performance of the virtual machine and achieving better virtualization services.

### CROSS-REFERENCE TO RELATED APPLICATION

This application claims priority to Chinese Patent Application No. CN202410516677.4, on file at the China National Intellectual Property Administration (CNIPA), having a filing date of Apr. 26, 2024, and having “METHOD OF MIGRATING VIRTUAL MACHINE, ELECTRONIC DEVICE AND COMPUTER PROGRAM PRODUCT” as a title, the contents and teachings of which are herein incorporated by reference in their entirety.

### TECHNICAL FIELD

Embodiments of the present disclosure generally relate to the field of data storage, and more particularly, relate to a method, a device, and a computer program product for migrating a virtual machine.

### BACKGROUND

Virtual machine (VM) is a virtual environment created on a physical hardware system using a virtualization technology as a virtual computer system, it can simulate a whole set of hardware of a computer, including CPU, memory, network interface, and storage. Through corresponding hypervisor software, resources and hardware can be separated and appropriately configured for use by VMs.

The virtualization technology allows a plurality of virtual environments to share a system. A VM hypervisor is configured to manage the hardware and separate physical resources from virtual environments. Resources from a physical environment, after partitioned as required, will be allocated to VMs. For example, physical storage resources will be mapped to logical storage resource units, i.e., datastores, and then the datastores are allocated to VMs by the VM hypervisor.

### SUMMARY OF THE INVENTION

Embodiments of the present disclosure provide a method, a device, and a computer program product for migrating a virtual machine. In a first aspect of the present disclosure, a method for migrating a virtual machine is provided. The method includes: acquiring a source operation status of a virtual machine on a source-type datastore. The method further includes: determining a plurality of candidate migration actions for migrating the virtual machine from the source-type datastore to various types of datastores respectively. The method further includes: determining a plurality of action scores of the plurality of candidate migration actions based on the source operation status and the plurality of candidate migration actions, the action score indicating the operational performance of the virtual machine on a datastore to which the virtual machine is migrated. The method further includes: selecting a target action from the plurality of candidate migration actions based on the plurality of action scores. The method further includes: migrating the virtual machine from the source-type datastore to a target-type datastore indicated by the target action by performing the target action.

In a second aspect of the present disclosure, an electronic device is provided. The electronic device includes at least one processing unit and at least one memory. The at least one memory is coupled to the at least one processing unit and stores instructions to be executed by the at least one processing unit. The instructions, when executed by the at least one processing unit, cause the electronic device to perform actions including: acquiring a source operation status of a virtual machine on a source-type datastore. The actions further include: determining a plurality of candidate migration actions for migrating the virtual machine from the source-type datastore to various types of datastores respectively. The actions further include: determining a plurality of action scores of the plurality of candidate migration actions based on the source operation status and the plurality of candidate migration actions. Here, the action score indicates the operational performance of the virtual machine on a datastore to which the virtual machine is migrated. The actions further include: selecting a target action from the plurality of candidate migration actions based on the plurality of action scores. The actions further include: migrating the virtual machine from the source-type datastore to a target-type datastore indicated by the target action by performing the target action.

In a third aspect of the present disclosure, a computer program product is provided. The computer program product is tangibly stored in a non-transitory computer storage medium and includes machine-executable instructions. The machine-executable instructions, when executed by a device, cause the device to perform any step of the method according to the first aspect of the present disclosure.

The Summary of the Invention part is provided to introduce in a simplified form the selection of concepts, which will be further described in the Detailed Description below. The Summary of the Invention part is neither intended to identify key features or essential features of the present disclosure, nor intended to limit the scope of the present disclosure.

### BRIEF DESCRIPTION OF THE DRAWINGS

The above and other objectives, features, and advantages of the present disclosure will become more apparent from the description of example embodiments of the present disclosure in further detail with reference to the drawings, and in the example embodiments of the present disclosure, the same reference numerals generally represent the same components.

FIG. 1 illustrates a schematic diagram of an example system in which some embodiments of the present disclosure can be implemented;

FIG. 2 illustrates a flow chart of an example method for migrating a virtual machine according to some embodiments of the present disclosure;

FIG. 3 shows a schematic diagram of an example device for determining migration actions according to some embodiments of the present disclosure;

FIG. 4 illustrates a flow chart of an example method of training a migration model according to some embodiments of the present disclosure; and

FIG. 5 is a schematic block diagram of an example device that may be used to implement embodiments of the present disclosure.

In various figures, identical or corresponding reference numerals represent identical or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Preferred embodiments of the present disclosure will be described in further detail below with reference to the drawings. Although the preferred embodiments of the present disclosure are shown in the drawings, it should be understood that the present disclosure may be implemented in various forms and should not be limited by the embodiments stated herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or the same objects. Other explicit and implicit definitions may also be included below.

As discussed above, datastores can be used to store operating system files, application files, data files, etc. of a VM. In other words, the VM is deployed in the datastores. In a virtual system, various types of datastores can be included.

Since different types of datastores have different protocols, the virtual machine, when running on different types of datastores, achieves different performance. The advantages and disadvantages of the different running performance may depend on many factors, including workloads, storage hardware, and configuration. In addition, the impact of the existence of snapshots on the performance of the virtual machine is gradually being taken seriously. Therefore, the factors that affect the performance of the virtual machine in general, for example, can include: workload, type of datastores, snapshot quantity, and hardware configuration.

In some cases of read-intensive workloads, the performance of a VM running on one type of datastore may initially be better than the performance of the VM running on another type of datastore, but as the snapshot quantity increases, the running performance of the VM degrades significantly and falls below that on the another type of datastore. In this case, a VM management module can issue a suggestion to migrate the VM. In the related art, a VM load balancing mechanism determines a target migration location of a VM based on CPU, network, storage, and other resource usages. However, this does not take into account the impact of the workload, the type of datastores, the snapshot quantity, and the hardware configuration.

But if all the above factors are to be considered, the selection of appropriate datastores will be very difficult and complex, because not only are workload types changing, but also software/hardware configuration is complex, the impact of which is hard to define. At this point, setting of an optimal datastore for different applications with a plurality of workloads, hardware, and configuration (such as snapshot quantity) can only rely heavily on the experiences and subjective judgment of operation and maintenance personnel, and it is impossible to choose objectively by considering all relevant factors.

In view of this, embodiments of the present disclosure propose a solution for selecting a target-type datastore based on action scores to solve one or more of the above problems and other potential problems. In this solution, based on a current source-type datastore, candidate migration actions for migration to available datastores can be determined. Then, based on an operation status of a VM on the source-type datastore, an action score for performing each of the candidate migration actions can be determined. The action score indicates the performance of the VM running on a new datastore after a migration action is performed, so that a candidate migration action for performance improvement can be selected and then performed.

In addition, in this solution, with the number of migrations increases, an action score table will be dynamically updated, and experience data in the action score table will further guide the migration of the VM. In the long run, the optimal performance of the VM can be achieved with relative few migrations. In this way, an optimal type of the datastore for the virtual machine is found by taking into account the operation status of the virtual machine, thereby enhancing the performance of the virtual machine and achieving better virtualization services. In addition, compared with the manners in the related art, embodiments of the present disclosure generally consider the operation status of the VM to cover all possible influencing factors to achieve the optimal performance of the VM. In addition, the solution of the embodiments of the preset disclosure does not rely on the experiences of operation and maintenance personnel, thereby improving the accuracy of selections.

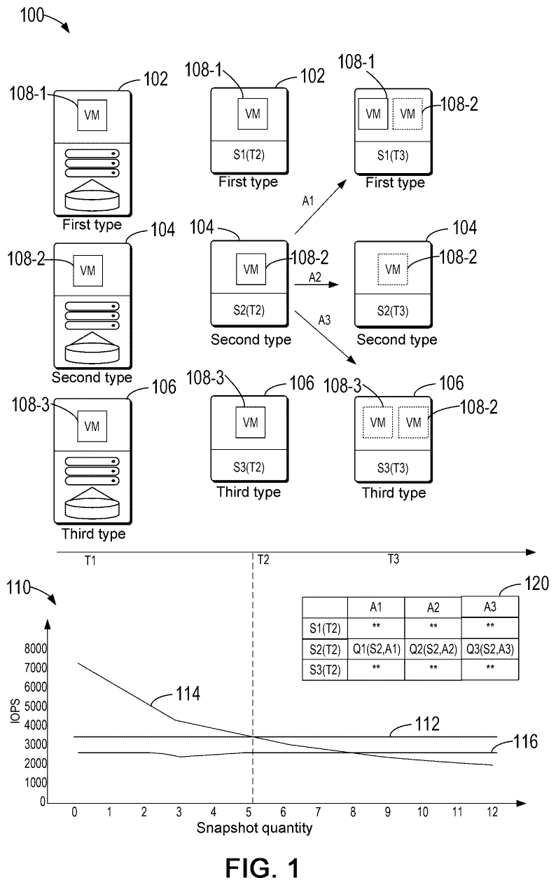

The basic principles and several example embodiments of a VM migration solution of the present disclosure will be described in detail below with reference to FIGS. 1-5. FIG. 1 illustrates a schematic diagram of an example system 100 in which some embodiments of the present disclosure can be implemented. The system 100 includes three types of datastores, including a first-type datastore 102, a second-type datastore 104, and a third-type datastore 106. In some embodiments, the first-type datastore 104 may, for example, be a virtual volume (vVol). The vVol is a framework for virtualization integration and management of a storage area network (SAN) and a network attached storage (NAS). This framework provides a more effective model for managing virtualized environments while transforming data centers from infrastructure-centric to application-centric. In such way, virtualization technologies serve applications better.

The second-type datastore 102 may, for example, be a virtual machine file system (VMFS). The VMFS is a high-performance cluster file system that provides storage virtualization that is optimized for VMs. Each VM is encapsulated in a small set of files; and the VMFS is the default storage management interface for these files on physical disks and partitions. The VMFS enables IT organizations to greatly simplify VM configuration by efficiently storing the entire machine status in a central location. The VMFS reduces the administrative overhead by providing an efficient virtualization management layer that is particularly suitable for large enterprise data centers.

The third-type datastore 106 may, for example, be a virtual storage area network (vSAN). The vSAN is a distributed layer of software that runs locally. The vSAN can aggregate local or direct-connected capacity devices of a host cluster and create a single storage pool shared among all hosts in the vSAN cluster. The vSAN uses a software-defined approach to create shared storage for VMs. Local physical storage resources of the hosts can be virtualized and converted into storage pools, which can then be partitioned and allocated to these VMs and applications based on QoS (quality of service) requirements of these VMs and applications.

A VM 108-1 runs on the first-type datastore 102. A VM 108-2 runs on the second-type datastore 104. A VM 108-3 runs on the third-type datastore 106.

As discussed above, since the three datastores are different in type, the overall performance will vary during running. In an embodiment shown in FIG. 1, a graph 110 shows variation processes of the performance of the same application in a VM running on the three types of datastores. Curves in the graph 110 show variations of IOPS (input/output per second) with the snapshot quantity. A curve 112 shows a variation process of the performance of the VM running on the first-type datastore 102, a curve 114 shows a variation process of the performance of the VM running on the second-type datastore 104, and a curve 116 shows the variation process of the performance of the VM running on the third-type datastore 106.

As can be seen, at time T1 when the snapshot quantity is relatively small at the beginning of running, the performance of the VM running on the second-type datastore 104 is significantly higher than the performance of the VM running on the other two types of datastores. However, as the snapshot quantity increases, the performance of the VM running on the second-type datastore 104 continuously degrades. At time T2 when the snapshot quantity reaches 5, the performance of the VM running on the second-type datastore 104 is equal to that running on the first-type datastore 102, and it can be predicted that the performance of the VM running on the second-type datastore 104 continues to degrade and will become lower than the performance of the VM running on the first-type datastore 102. At this point, the VM 108-2 can send a migration request to a VM management module to trigger a migration action.

After receiving the migration request of the VM 108-2, the VM management module determines that the system 100 includes three types of datastores so that the VM 108-2 can be migrated to the first-type datastore 102 by performing a first migration action A1. The VM 108-2 can also be retained in the second-type datastore 104 by performing a second migration action A2. The VM 108-2 can be migrated to the third-type datastore 106 by performing a third migration action A3. The VM management module determines an operation status S2(T2) of the VM 108-2 running on the second-type datastore 104 at time T2. According to the operation status S2(T2), the VM management module can search an action score table 120 for an action score Q1(S2, A1) for performing the first migration action A1, an action score Q1(S2, A2) for performing the second migration action A2, and an action score Q3(S2, A3) for performing the third migration action A3.

Here, the action score can indicate performance indexes of the VM on a datastore to which the VM is migrated. For example, at time T3 after the first migration action A1 is performed, the VM 108-2 is migrated to the first-type datastore 102. At this point, according to the graph 110, the VM 108-2 has the highest running performance on the first-type datastore 102. Therefore, the action score Q1(S2, A1) has a maximum value. At time T3 after the second migration action A2 is performed, the VM 108-2 is retained in the second-type datastore 104. At this point, according to the graph 110, the VM 108-2 has the lowest running performance on the second-type datastore 104. Therefore, the action score Q2(S2, A2) has a minimum value. At time T3 after the third migration action A3 is performed, the VM 108-2 is migrated to the third-type datastore 106. At this point, according to the graph 110, the VM 108-2 has the second highest running performance on the third-type datastore 102. Therefore, the action score Q1(S2, A1) has the second highest value.

As a result, the VM management module can determine, based on the action scores, that performing the first migration action A1 will get the highest benefit, and then select and perform the first migration action A1. In this way, for example, when the VM autonomously sends a migration request to trigger a migration to a datastore, the system 100 can determine an optimal target-type datastore and a migration action according to the action scores, thereby automatically achieving a VM migration.

It should be understood that the system 100 shown in FIG. 1 is merely illustrative and not restrictive. A storage system according to the present disclosure may also have other forms or structures.

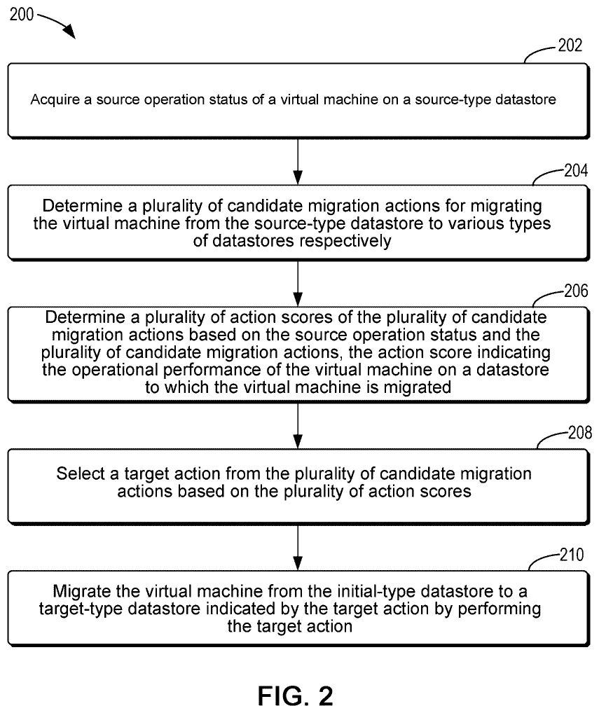

The basic principles and several example embodiments of the present disclosure will be described in detail below with reference to the drawings. FIG. 2 illustrates a flow chart of an example method 200 for migrating a VM according to some embodiments of the present disclosure. For ease of illustration, the method 200 will be described with reference to FIG. 1. The method 200 can be implemented by the system 100 or the VM management module in the system. It should be understood that the method 200 can also be performed by other appropriate devices or apparatuses. The method 200 may include additional actions not shown and/or may omit actions shown, and the scope of the present disclosure is not limited in this regard.

As shown in FIG. 2, at 202, the method 200 includes acquiring a source operation status of a VM on a source-type datastore. For example, in the embodiment shown in FIG. 1, the system 100 can acquire the source operation status S2(T2) of the VM 108-2 on the source-type datastore 104. The operation status includes, for example, parameters capable of reflecting the running performance of the VM, such as delay or throughput. The operation status can further include environmental parameters associated with the running performance of the VM, such as hardware configuration.

At 204, the method 200 includes determining a plurality of candidate migration actions for migrating the VM from the source-type datastore to various types of datastores respectively. For example, in the embodiment shown in FIG. 1, the system 100 can determine that the system 100 includes three types of datastores and that candidate migration actions for a current VM include the first migration action A1, the second migration action A2, and the third migration action A3.

At 206, the method 200 includes determining a plurality of action scores of the plurality of candidate migration actions based on the source operation status and the plurality of candidate migration actions. Here, the action score indicates the operational performance of the virtual machine on a datastore to which the virtual machine is migrated. For example, in the embodiment shown in FIG. 1, the system 100 can determine three action scores Q1, Q2, and Q3 respectively based on the source operation status S2(T2) as well as the first migration action A1, the second migration action A2, and the third migration action A3. In some embodiments, the action score table can be generated by directly recording historical running information of the system. In some alternative embodiments, the action score table may also be an action score function derived from the historical running information of the system according to a specific fitting method. The action score function is, for example, a function for operation statuses and migration actions.

At 208, the method 200 includes selecting a target action from the plurality of candidate migration actions based on the plurality of action scores. For example, in the embodiment shown in FIG. 1, the system 100 can select the migration action A1 with a maximum action score Q1. In some embodiments, the system may also select a migration action whose action score is greater than a predetermined score threshold.

At 210, the method 200 includes migrating the VM from the source-type datastore to a target-type datastore indicated by the target action by performing the target action. For example, in the embodiment shown in FIG. 1, the system 100 may perform the migration action A1 to migrate the VM 108-2 from the source-type datastore 104 to the target-type datastore 102.

In the embodiment shown in FIG. 2, an optimal type of the datastore for the virtual machine is found by taking into account the operation status of the virtual machine, thereby enhancing the performance of the virtual machine and achieving better virtualization services. In addition, the solution of the embodiments of the preset disclosure can be performed autonomously without relying on the experiences of operation and maintenance personnel, thereby ensuring the timeliness of VM migration and improving the accuracy of selection of the target-type datastore.

In some embodiments, the system can also, depending on a setting, recommend an optional datastore with an action score within a certain threshold range to a user without directly performing the migration action. As a result, the user can select his/her preferred datastore timely, thus improving the user experience.

As discussed above, in the related art, for different applications on different VMs (with different workloads), users often need experienced operation and maintenance personnel to try several steps to find an optimal datastore. At the same time, even experienced operation and maintenance personnel may not know appropriate migration targets. Therefore, embodiments of the present disclosure further propose a reinforcement learning-based framework for efficiently obtaining an action evaluation table. In the reinforcement learning-based framework, a VM is assumed to be running on one type of datastore. Here, it is expected to find an optimal datastore for the VM to maximize the running performance of the VM, or allow the VM to achieve the target performance by migrating the VM for multiple times.

In the reinforcement learning-based framework, an agent is configured. The agent observes an operation status s(t) of the VM at time step t. Then, the agent selects a migration action A(t) according to an action selection strategy, and transitions to a next status s(t+1) at next time step t+1. The agent computes a reward r(t+1) based on the status s(t+1). Therefore, there is a time step between the two statuses. After that, the agent utilizes, including but not limited to, a Q learning algorithm, a deep Q network (DQN) algorithm, and a dual DQN (DDQN) algorithm to update action evaluation values in the action evaluation table or an action evaluation function Q(s,a). The action evaluation function or action evaluation values define a long-term value of taking action a in any status s. Over time, the agent can then learn to pursue actions that get the greatest cumulative return or reward in any status.

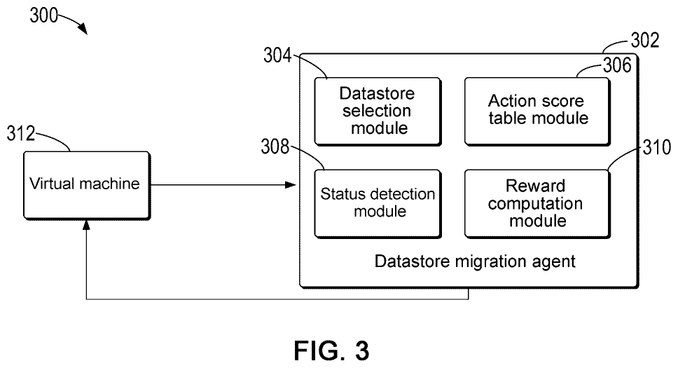

The reinforcement learning-based framework for efficiently obtaining an action evaluation table is described below with reference to FIGS. 3-5. FIG. 3 shows a schematic diagram of an example device 300 for determining migration actions according to some embodiments of the present disclosure. As shown in FIG. 3, the device 300 includes a datastore migration agent 302. The datastore migration agent 302 is an agent that autonomously learns to select datastores based on reinforcement learning, which is designed to find an optimal datastore to maximize the performance of a VM.

The datastore migration agent 302 includes a datastore selection unit 304. The datastore selection unit 304 observes a current operation status s(t) of a VM 312 and provides migration operations for the datastores. The datastore migration agent 302 further includes an action score table module 306. The action score table module 306 uses a reinforcement learning algorithm to update an action score based on the current status of the VM 312, a migration action for the VM 312, a reward after the VM 312 is migrated, and a status of the VM 312 at the next moment. The datastore migration agent 302 further includes a status detection module 308. The status detection module 308 acquires operation statuses of the VM 312. The operation statuses, for example, include static information and running implementation information, such as VM information, hardware configuration, runtime performance matrices (such as I/O delay/IOPS/CPU usage), workloads (such as I/O size/read/write ratio), snapshot quantity, and current data storage. The datastore migration agent 302 further includes a reward computation module 310. The reward computation module 310 computes an action reward in the status s(t) according to a target: finding an optimal datastore maximizing the performance of the VM.

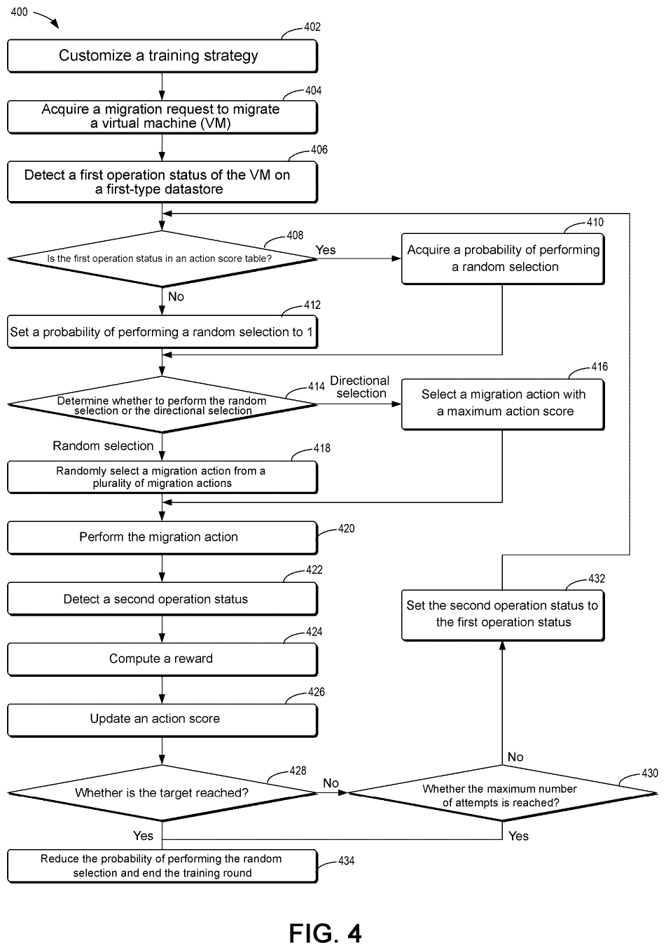

So far, the example device 300 for performing a reinforcement learning-based framework for efficiently obtaining an action evaluation table has been described, and then a method flow for efficiently obtaining an action evaluation table is described below with reference to FIG. 4. FIG. 4 illustrates a flow chart of an example method of training a migration model according to some embodiments of the present disclosure. For example, the method 400 may be implemented by the device 300 in FIG. 3. It should be understood that the method 400 can also be performed by other appropriate devices or apparatuses, such as the system 100 in FIG. 1 or the device in the system 100. The method 400 may include additional actions not shown and/or may omit actions shown, and the scope of the present disclosure is not limited in this regard.

As shown in FIG. 4, at 402, the device 300 customizes a training strategy. The training strategy includes: a list of acceptable datastores, a maximum number of training attempts, and an acceptable performance range, such as: a delay less than 5 ms. At 404, the device 300 acquires a migration request to migrate a VM from the VM. The request may be triggered automatically by a VM with performance issues, which means that the VM should be migrated. For example, for an application with a workload of 512 KB sequential read IOPS on a VMFS, when the snapshot quantity exceeds 5, a migration request will be generated due to performance degradation.

At 406, the device 300 detects a first operation status of the VM on a first-type datastore. Here, the operation status is a vector at a moment. It Indicates a static and real-time system status of a particular VM at time step t. In some embodiments, the operation status may include being expressed as:

$$s = \{ {VM}_{info} , Snum , DS , WL , HD conf . , {rt}_{info} \} \qquad ( 1 )$$

where VM_{info} represents VM information; Snum represents snapshot quantity; DS represents an optional-type datastore; WL represents workload; HD conf. represents hardware configuration; rt_{info} represents runtime information.

In the embodiment shown, the VM information is a static value that represents information about a VM, including, for example, but not limited to, the type of an operating system, the number of CPUs, the size of a memory, and the size of a hard disk. The data storage determines the format of the application, such as VMFS, vSAN, and vVol. The workload represents average IO information over a time period, including, for example, but not limited to, IO size, read/write ratio, and IO type (e.g., random or sequential). The hardware configuration represents hardware configuration of a storage system, such as hardware, platform, and drive information. The runtime information represents an average runtime status (such as performance status) during time step t, such as rounded-off values of an average total throughput, an average CPU usage, and an average delay. An example status is listed below:

### <VM Information>

Operating system=CentOS 7 (64-bit)
CPU=4
Memory=4 GB
Hard disk=300 GB
<Data storage>VMFS

### <Workload>

Average_IO size=512 (KB)
Read/write ratio=95 (read percentage)
Random/Sequential ratio=0 (random percentage)

### <Snapshot_number>

6

### <Hardware Configuration>

System Hardware: <Hardware>
System Platform: <Platform>
Drive Information: <Drive>

### <Runtime Information>

Average total_IOPS=50 (K)
Average throughput=250 (MB/S)
Average CPU usage=70 (%)
Average delay=2 (ms).

At 408, the device 300 determines whether the first operation status is in an action score table. When the device 300 determines that the first operation status is in the action score table, the method 400 proceeds to 410. At 410, the device 300 acquires a probability of performing a random selection. When the device 300 determines that the first operation status is not in the action score table, the method 400 proceeds to 412. At 412, the probability of performing a random selection is set to 1. Here, the device 300 can select to perform the random selection or a directional selection based on the probability, where the random selection corresponds to “exploration,” while the directional selection corresponds to “exploitation.” When an operation status is not recorded in the action score table, that is, no action score can indicate the advantages and disadvantages of a migration action for a current operation status. Therefore, the device 300 has no information to “exploit” and can only select “explore.” The device 300 sets the probability to 1, so that it is inevitable to perform the random selection.

In contrast, when an operation status is recorded in the action score table, that is, the action score table includes an action score that can indicate the advantages and disadvantages of a migration action for a current operation status. Therefore, the device 300 has information that can be “exploited.” However, if the device 300 selects previously recorded information every time, it will not be able to traverse all selections. Therefore, the device 300 still needs to perform exploration. At this point, the probability of performing a random selection is set in a range of 0 to 1.

At 414, the device 300 determines whether to perform the random selection or the directional selection according to the probability. When the device 300 determines to perform the directional selection according to the probability, the method 400 proceeds to 416. At 416, the device 300 selects a migration action with a maximum action score. When the device 300 determines to perform the random selection according to the probability, the method 400 proceeds to 418. At 418, the device 300 randomly selects a migration action from a plurality of feasible migration actions. In some embodiments, the feasible migration actions may be migration actions in an action space. For example, when the system includes three types of datastores, i.e., VMFS, vSAN, and vVol, the action space may be:

TABLE 1
Action Space

| Action | | Current Data | New Data |
|---|---|---|---|
| Number | Action | storage | storage |
| 1 | vSAN->VMFS | vSAN | VMFS |
| 2 | vSAN->vVol | vSAN | vVol |
| 3 | VMFS->vSAN | VMFS | vSAN |
| 4 | VMFS->vVol | VMFS | vVol |
| 5 | vVol->VMFS | vVol | VMFS |
| 6 | vVol->vSAN | vVol | vSAN |
| 7 | vSAN->vSAN | vSAN | vSAN |
| 8 | VMFS -> VMFS | VMFS | VMFS |
| 9 | vVol->vVol | vVol | vVol |

For example, when the current datastore is a VMFS, the feasible actions in the action space are: VMFS−>vSAN, VMFS−>vVol, VMFS−>VMFS.

After a migration action is selected, at 420, the device 300 performs an operation action to migrate the VM from a first-type datastore to a second-type datastore. At 422, the device 300 detects a second operation status of the VM on the second-type datastore. At 424, the device 300 computes a reward based on the first operation status, the second operation status, and the selected migration action.

In some embodiments, a reward function R can be defined to guide the agent to find a good solution for a given target. Since the target is to find optimal data storage maximizing the performance of the VM, the reward R can be defined as follows:

$$R = W 1 * ( \frac{- {L}_{A} + {L}_{I}}{{L}_{I}} ) + W 2 * ( \frac{{T}_{A} + {T}_{I}}{{T}_{I}} ) \qquad ( 2 )$$

Where W1 and W2 are corresponding weights; L_{A} represents an average delay, that is, an average delay during a time duration of migrating the VM from the first-type datastore to the second-type datastore (corresponding to a time slot between the time of detecting the first operation status and the time of detecting the second operation status). L_{I} represents an initial delay, that is, a delay of the VM on the first-type datastore; T_{A} represents an average throughput, that is, an average throughput during a time duration of migrating the VM from the first-type datastore to the second-type datastore; T_{I} represents an initial throughput, that is, a throughput of the VM on the first-type datastore. W1 and W2 values depend on user concerns about the delays and the throughputs.

At 426, the device 300 updates action scores according to the reinforcement learning formula based on the first operation status, the second operation status, the selected migration action, and the reward. In some embodiments, the formula for updating may be an update formula in a Q learning algorithm, a DON learning algorithm, or a DDQN learning algorithm. As the training progresses, the action scores tend to become stable and thus converge.

At 428, the device 300 determines whether the target is reached. For example, whether the running performance is within a predefined acceptable range. When the device 300 determines that the target is not reached, the method 400 proceeds to 430. At 430, the device 300 determines whether a maximum number of attempts, for example, 3, is reached. When the device 300 determines that the maximum number of attempts is not reached, the method 400 proceeds to 432. At 432, the device 300 sets the current second operation status to the first operation status to return to 408, thereby triggering a new iteration.

When the device 300 determines that the target is reached, the method 400 proceeds to 434. In addition, when the device 300 determines that the maximum number of attempts is reached, the method 400 also proceeds to 434. At 434, the device 300 reduces the probability of performing the random selection and ends the training round.

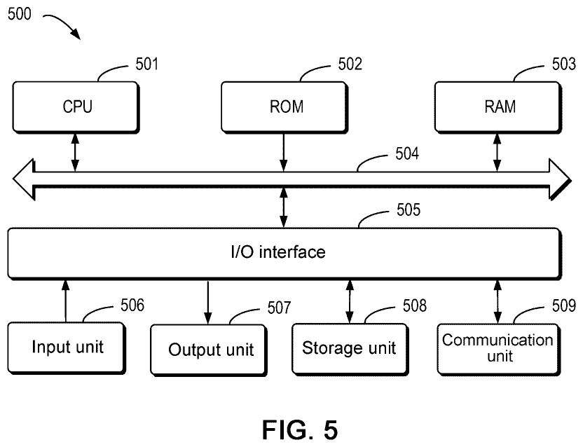

FIG. 5 illustrates a schematic block diagram of an example device 500 that may be used to implement embodiments of the present disclosure. For example, the storage system 100 as shown in FIG. 1 can be implemented by the device 500. As shown in FIG. 5, the device 500 includes a central processing unit (CPU) 501 which may perform various appropriate actions and processing according to computer program instructions stored in a read-only memory (ROM) 502 or computer program instructions loaded from a storage unit 508 to a random access memory (RAM) 503. Various programs and data required for the operation of device 500 may further be stored in RAM 503. The CPU 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, such as a keyboard and a mouse; an output unit 507, such as various types of displays and speakers; the storage unit 508, such as a magnetic disk and an optical disc; and an communication unit 509, such as a network card, a modem, and a wireless communication transceiver. The communication unit 509 allows the device 500 to exchange information/data with other devices via a computer network, such as the Internet, and/or various telecommunication networks.

The various methods and processing described above, such as the methods 200 and 400, may be performed by the processing unit 501. For example, in some embodiments, the methods 200 and 400 may be implemented as a computer software program that is tangibly included in a machine-readable medium, such as the storage unit 508. In some embodiments, part of or all the computer program may be loaded and/or installed to the device 500 via the ROM 502 and/or the communication unit 509. When the computer program is loaded into the RAM 503 and executed by the CPU 501, one or more actions of the method 300 described above may be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages such as Smalltalk and C++, and conventional procedural programming languages such as C language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, apparatus (system), and computer program product according to embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce means (e.g., specialized circuitry) for implementing the functions/acts specified in one or more blocks in the flow charts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The terminology used herein is chosen to best explain the principles, practical application, or improvement of technology in the market of various embodiments, or to enable those of ordinary skill in the art to understand various embodiments disclosed herein.

What is claimed is:

1. A method for migrating a virtual machine, comprising:
acquiring a source operation status of a virtual machine on a source-type datastore;
determining a plurality of candidate migration actions for migrating the virtual machine from the source-type datastore to various types of datastores respectively;
determining a plurality of action scores of the plurality of candidate migration actions based on the source operation status and the plurality of candidate migration actions, the action score indicating the operational performance of the virtual machine on a datastore to which the virtual machine is migrated;
selecting a target action from the plurality of candidate migration actions based on the plurality of action scores; and
migrating the virtual machine from the source-type datastore to a target-type datastore indicated by the target action by performing the target action.

2. The method according to claim 1, wherein the plurality of action scores are determined using a trained reinforcement learning model.

3. The method according to claim 2, wherein the reinforcement learning model is trained by the following steps:
detecting a first operation status of the virtual machine on a first-type datastore;
performing a first migration action so that the virtual machine is migrated from the first-type datastore to a second-type datastore;
detecting a second operation status of the virtual machine on the second-type datastore;
determining a first reward for performing the first migration action; and
based on the first operation status, the second operation status, the first reward, and the first migration action, determining a first action score for performing the first migration action performed in the first operation status.

4. The method according to claim 3, wherein determining the first reward comprises:
determining a first delay and a first throughput indicated by the first operation status;
detecting an average delay and an average throughput during a process of migrating the virtual machine from the first-type datastore to the second-type datastore; and
determining the first reward based on a difference between the first delay and the average delay and a difference between the first throughput and the average throughput.

5. The method according to claim 3, further comprising:
determining a plurality of migration actions for migrating the virtual machine from the first-type datastore to the various types of datastores respectively;
determining whether the first operation status is in an action score table for maintaining action scores;
in response to a determination that the first operation status is not in the action score table, adding the first operation status to the action score table; and
randomly selecting the first migration action from the plurality of migration actions.

6. The method according to claim 5, further comprising:
in response to a determination that the first operation status is in the action score table, determining a probability of performing a random selection on migration actions;
according to the probability, determining to perform the random selection or a directional selection based on the action score table; and
in response to a determination to perform the random selection, randomly selecting a migration action from the various types of migration actions as the first migration action.

7. The method according to claim 6, further comprising:
in response to a determination to perform the directional selection, selecting a migration action with the highest action score from the various types of migration actions as the first migration action.

8. The method according to claim 3, further comprising:
acquiring a training strategy that comprises the following items: a list of datastores, a maximum number of performed migration actions, and a target performance range; and
in response to a determination that the second operation status is within the target performance range, ending a current training round; or
in response to a determination that the second operation status is not within the target performance range, determining whether the number of performed migration actions reaches the maximum number; and
in response to a determination that the number does not reach the maximum number, updating the second operation status to the first operation status.

9. The method according to claim 3, wherein the detection of the first operation status is triggered by receiving a migration request, and the migration request is sent by the virtual machine at a time of performance degradation.

10. The method according to claim 1, wherein the source operation status comprise at least one of: virtual machine information, snapshot quantity, type of datastores, workload, hardware setting, or operational performance index.

11. An electronic device, comprising:
at least one processor; and
at least one memory having computer program instructions stored thereon, the at least one memory and the computer program instructions being configured to, together with the at least one processor, cause the electronic device to perform actions comprising:
acquiring a source operation status of a virtual machine on a source-type datastore;
determining a plurality of candidate migration actions for migrating the virtual machine from the source-type datastore to various types of datastores respectively;
determining a plurality of action scores of the plurality of candidate migration actions based on the source operation status and the plurality of candidate migration actions, the action score indicating the operational performance of the virtual machine on a datastore to which the virtual machine is migrated;
selecting a target action from the plurality of candidate migration actions based on the plurality of action scores; and
migrating the virtual machine from the source-type datastore to a target-type datastore indicated by the target action by performing the target action.

12. The electronic device according to claim 11, wherein the plurality of action scores are determined using a trained reinforcement learning model.

13. The electronic device according to claim 12, wherein the reinforcement learning model is trained by the following steps:
detecting a first operation status of the virtual machine on a first-type datastore;
performing a first migration action so that the virtual machine is migrated from the first-type datastore to a second-type datastore;
detecting a second operation status of the virtual machine on the second-type datastore;
determining a first reward for performing the first migration action; and
based on the first operation status, the second operation status, the first reward, and the first migration action, determining a first action score for performing the first migration action performed in the first operation status.

14. The electronic device according to claim 13, wherein determining the first reward comprises:
determining a first delay and a first throughput indicated by the first operation status;
detecting an average delay and an average throughput during a process of migrating the virtual machine from the first-type datastore to the second-type datastore; and
determining the first reward based on a difference between the first delay and the average delay and a difference between the first throughput and the average throughput.

15. The electronic device according to claim 13, further comprising:
determining a plurality of migration actions for migrating the virtual machine from the first-type datastore to the various types of datastores respectively;
determining whether the first operation status is in an action score table for maintaining action scores;
in response to a determination that the first operation status is not in the action score table, adding the first operation status to the action score table; and
randomly selecting the first migration action from the plurality of migration actions.

16. The electronic device according to claim 15, further comprising:
in response to a determination that the first operation status is in the action score table, determining a probability of performing a random selection on migration actions;
according to the probability, determining to perform the random selection or a directional selection based on the action score table; and
in response to a determination to perform the random selection, randomly selecting a migration action from the various types of migration actions as the first migration action.

17. The electronic device according to claim 16, further comprising:
in response to a determination to perform the directional selection, selecting a migration action with the highest action score from the various types of migration actions as the first migration action.

18. The electronic device according to claim 13, further comprising:
acquiring a training strategy that comprises the following items: a list of datastores, a maximum number of performed migration actions, and a target performance range; and
in response to a determination that the second operation status is within the target performance range, ending a current training round; or
in response to a determination that the second operation status is not within the target performance range, determining whether the number of performed migration actions reaches the maximum number;
in response to a determination that the number does not reach the maximum number, updating the second operation status to the first operation status.

19. The electronic device according to claim 11, wherein the various types of datastores comprise: a virtual machine file system (VMFS), a virtual volume (Vvol), or a virtual storage area network (vSAN).

20. A computer program product having a non-transitory computer readable medium which stores a set of instructions to migrate a virtual machine; the set of instructions, when carried out by computerized circuitry, causing the computerized circuitry to perform a method of:
acquiring a source operation status of a virtual machine on a source-type datastore;
determining a plurality of candidate migration actions for migrating the virtual machine from the source-type datastore to various types of datastores respectively;
determining a plurality of action scores of the plurality of candidate migration actions based on the source operation status and the plurality of candidate migration actions, the action score indicating the operational performance of the virtual machine on a datastore to which the virtual machine is migrated;
selecting a target action from the plurality of candidate migration actions based on the plurality of action scores; and
migrating the virtual machine from the source-type datastore to a target-type datastore indicated by the target action by performing the target action.
